(19) United States
(12) Patent Application Publication
(10) Pub. No.: US 2009/0180299 A1
(43) Pub. Date: Jul. 16, 2009

(54) SURFACE LIGHT SOURCE AND DISPLAY DEVICE

(75) Inventors: Shin ITO, Mihara-shi (JP); Yutaka OKADA, Nara-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 12/352,971

(22) Filed: Jan. 13, 2009

(30) Foreign Application Priority Data
Jan. 15, 2008 (JP) 2008-5230

(51) Int. Cl. F21V 7/22

(52) U.S. Cl. 362/619

(57) ABSTRACT

A surface light source includes: a light guiding plate including, in a main region, a light emitting surface and a back surface facing the light emitting surface; and a light source being provided on a back surface side in an end region of the light guiding plate, the light source emitting light so that the light emitted from the light emitting surface. The surface light source further includes: an inclining surface being formed along an end section on the light emitting surface side in the end region so that the light guiding plate becomes thinner toward the end section; a reflecting member covering the inclining surface; and a light incident end face being provided on the back surface side and extending along the end section, the inclining surface being formed so that light entering the light incident end face at a right angle is totally reflected by the light incident end face after being reflected by the inclining surface or the reflecting member. With this arrangement, it is possible to realize a surface light source that is larger in size and thinner in thickness, and a display device having a narrower frame.

This Nonprovisional application claims priority under U.S.C. §119(a) on Patent Application No. 005230/2008 filed in Japan on Jan. 15, 2008, the entire contents of which are hereby incorporated by reference.

### FIELD OF THE INVENTION

The present invention relates to a surface light source including a light guiding plate and to a display device including a display panel which is backlighted by the surface light source.

### BACKGROUND OF THE INVENTION

As a surface light source such as a backlight that backlights a liquid crystal display panel, there has been a surface light source that includes a light guiding plate and a light source such as LED, wherein light from the light source is received at a light incident end face of the light guiding plate, so that diffused light is emitted from the surface light source. There has also been a liquid crystal display device including the surface light source. In response to an increase in size of the liquid crystal display device, there has been a rise in demand for a reduction in size and thickness of the surface light source and for a narrower frame for surrounding a screen of a liquid crystal display panel.

Patent Literature 1 (Japanese Unexamined Patent Publication No. 2007-294191, publication date: Nov. 8, 2007) discloses a surface light source that includes a light guiding plate and an LED array serving as a light source for irradiating an end face of the light guiding plate.

The light guiding plate has an inclining back surface, a flat light emitting surface having a rectangular shape, and light incident end faces that are a pair of end faces facing each other in a longitudinal direction of the light guiding plate. The back surface is covered with a reflecting member. The LED array is provided so as to face the light incident end faces.

With this arrangement, light emitted from the LED array enters the light guiding plate through the light incident end faces and then passes through an inside of the light guiding plate while being scattered by scattering particles that are provided inside the light guiding plate. Then, the light is emitted from the light emitting surface directly or after being reflected by the back surface.

Patent Literature 2 (Japanese Unexamined Patent Publication No. 2007-121597, publication date: May 17, 2007) discloses a surface light source that includes a light guiding plate, a light source being provided above the light guiding plate and emitting light in a direction perpendicular to a longer direction of the surface light source, and a pair of reflecting plates for diffusing the light into the light guiding plate.

The light guiding plate has a light emitting surface and a back surface. The light emitting surface is a planar surface whereas the back surface is curved so that the light guiding plate becomes thinner toward its ends. Further, one of the reflecting plates is provided so as to cover a curved part of the back surface. Meanwhile, the other reflecting plate is provided along the light source on the light emitting surface. The light source is provided at the end of the light emitting surface and emits light into said one of the reflecting plates so that the light passes in a direction perpendicular to the light emitting surface from the light emitting surface.

With this arrangement, the light emitted from the light source into the light guiding plate is outputted from the light emitting surface after being reflected by the reflecting plates.

These light guiding plates change their sizes by expanding or contracting in response to a change in surrounding temperature. This phenomenon occurs significantly in a large light guiding plate. For example, in a case where the surrounding temperature is changed by 20° C., the light guiding plate changes its size by approximately 1.4 mm per 1 m of the light guiding plate.

Therefore, in the surface light source disclosed in Patent Literature 1, it is necessary to form a gap between the light incident end faces and the LED array so that a change in size of the guiding plate can be absorbed.

However, there is a problem in that the size of the gap varies in response to a change in temperature; and this variation in size of the gap causes a change in coupling efficiency of light between the light incident end faces and the LED array. Further, it is necessary to make the gap larger in size in order to absorb the size change of the light guiding plate over a wide range of temperature. This causes a decrease in the coupling efficiency. Furthermore, it is necessary to release heat in order to prevent the LED array from increasing in temperature. However, a long and thin reed shape of the LED array makes it difficult to obtain a sufficient heat releasing area without any further arrangement.

With the surface light source disclosed in Patent Literature 2, in which the light source is mounted on a flexible substrate and is sandwiched between the flexible substrate and the light guiding plate, it is difficult to release the heat to a sufficient extent. Further, Patent Literature 2 does not disclose means, provided between the light source and the flexible substrate or the light guiding plate, for absorbing the size change caused by the change in surrounding temperature.

These problems have been preventing the surface light source from becoming larger in size and thinner in thickness, and preventing the display device from having a narrower frame.

### SUMMARY OF THE INVENTION

The present invention has been accomplished in view of the problems above, and an object of the present invention is to provide a surface light source and a liquid crystal display device that have a high degree of freedom of heat release designing and advantageously achieve increase in size and decrease in thickness of the surface light source, and decrease in thickness of frame of the display device.

In order to attain the object, a surface light source of the present invention is a surface light source including: a light guiding plate including, in a main region, a light emitting surface for emitting light and a back surface facing the light emitting surface; a light source being provided on a back surface side in an end region of the light guiding plate, and emitting the light to be emitted from the light emitting surface; an inclining surface being formed along an end section on the light emitting surface side in the end region so that the light guiding plate becomes thinner toward the end section; a reflecting member covering the inclining surface; and a light incident end face being provided on the back surface side and extending along the end section, the inclining surface being formed so that light entering the light incident end face at a right angle is totally reflected by the light incident end face after being reflected by the inclining surface or the reflecting member.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1(a) and FIG. 1(b) are views showing structures of a light emitting device and an array light source, respectively.

FIG. 2 is a view showing an arrangement of a surface light source.

FIG. 3 is a view showing a cross-sectional structure of an end region of a light guiding plate.

FIG. 4 is a cross-sectional view of a liquid crystal display device.

FIG. 5(a) through FIG. 5(d) are views each showing a vicinity of an end region of a surface light source.

FIG. 6(a) and FIG. 6(b) are views each showing a relation between an incident angle and a reflection angle at a boundary surface between atmosphere and a light guiding plate.

### DESCRIPTION OF THE EMBODIMENTS

### First Embodiment

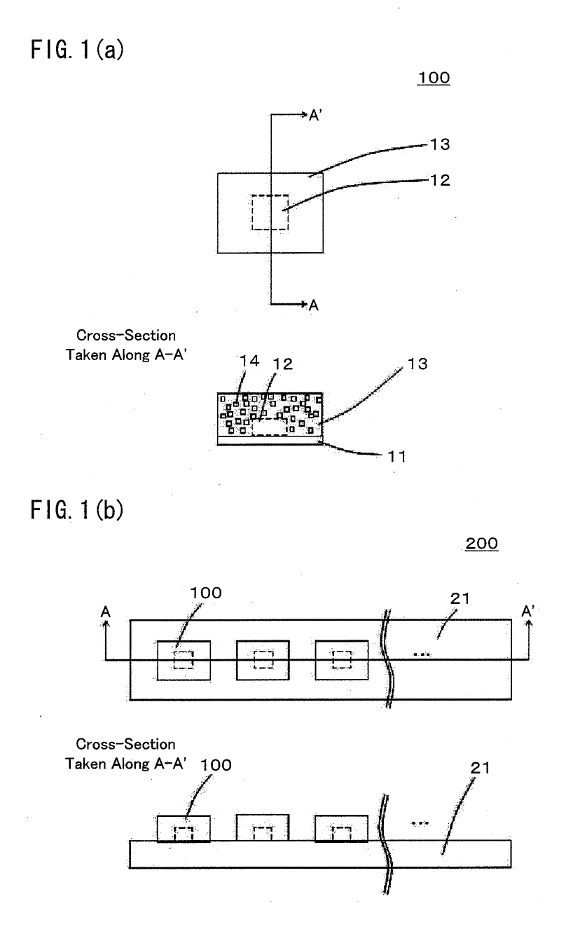

One embodiment of the present invention is described below with reference to FIG. 1(a) through FIG. 3.

### (Light Emitting Device)

FIG. 1(a) is a view showing a structure of a light emitting device. A light emitting device 100, which serves as a light source, is a so-called resin mold type package and includes a substrate 11, a chip 12 die-bonded to the substrate 11, and a resin 13 covering the substrate 11 and the chip 12. Fluorescent materials 14 are dispersed in the resin 13 in advance.

The chip 12 is a nitride semiconductor light emitting diode that emits primary light, that is, blue light having an emission peak wavelength of approximately 450 nm.

The substrate 11 is formed from a material having a high thermal conductivity so as to rapidly release heat generated by operation of the chip 12. The substrate 11 is suitably formed from a material such as ceramic, which achieves a high heat release. On the substrate 11, a line for electrically connecting the chip 12 and other materials are formed in advance.

The resin 13 is suitably formed from a silicone resin or the like, which is highly resistant to the primary light and secondary light. Dispersed in the resin 13 in advance are the fluorescent materials 14 for absorbing the primary light and for emitting the secondary light that has a different wavelength from the primary light.

The fluorescent materials 14 can be yellow fluorescent materials that absorb the primary light and emit the secondary light, that is, yellow light having a peak wavelength of approximately 560 nm.

Alternatively, the fluorescent materials 14 can be, instead of the yellow fluorescent material, a red fluorescent material or a green fluorescent material that absorbs the primary light and emits red secondary light or green secondary light, respectively.

The light emitting device 100 emits white light because the primary light emitted from the chip is mixed with the secondary light, which the fluorescent materials 14 dispersed in the resin 13 emit by absorbing part of the primary light that passes through the resin 13.

Further, instead of the chip 12 that emits blue light, a chip that emits UV light as the primary light can be used in combination with the fluorescent materials that absorb the primary light and emit red, green, and blue secondary light, respectively.

With the arrangement in which two or more types of the fluorescent materials are dispersed in the resin 13, it becomes possible to make red components be sufficiently included in a spectrum distribution of emitted light from the light emitting device 100. This makes it possible to improve color rendering compared to a case where only the yellow fluorescent materials are used.

Angular dependence of emission intensity of the light emitting device 100 is represented by a distribution known as the Lambertian distribution, and is represented as cos θ, wherein an angle θ is measured with respect to a line perpendicular to a light emitting surface of the light emitting device 100, that is, with respect to an optical axis. According to this distribution, optical components emitted in a direction parallel to the optical axis have the highest emission intensity; and optical components emitted in a lateral direction have an emission intensity lowered in response to an increase in the angle.

The light emitting device 100 does not include any reflecting member such as a reflector that surrounds the chip 12, except for total reflection at a surface of the substrate 11 or an outer surface of the package. Therefore, an angular distribution of the emitted light becomes broader. However, it is possible to alleviate light intensity reduction due to multiple reflections that also send the light backward. This allows the light emitting device 100 to have a high light extraction efficiency.

FIG. 1(b) is a view showing a structure of an array light source. An array light source 200 includes a mounting substrate 21 and a plurality of light emitting devices 100 linearly provided on the mounting substrate 21. The array light source 200 has a reed shape and emits light so that the light enters a later-mentioned light guiding plate along one side of the light guiding plate.

The mounting substrate 21 is formed from a material having a high thermal conductivity so as to rapidly release heat generated by the light emitting devices 100. The mounting substrate 21 is suitably formed from a material such as aluminium, which achieves a high heat release. On the mounting substrate 21, a line for electrically connecting the light emitting devices 100 and other materials are formed in advance.

The light emitting devices 100 each may include three or more types of chips that emit blue light, green light, and red light, respectively. In this case, the chips are integrally packaged so that the light emitting device 100 emits white light by mixing the light. Alternatively, the light emitting devices 100 each may emit any one of blue light, green light, and red light; and the array light source 200 is constituted by a combination of these light emitting devices 100. Further, the array light source can be a cold-cathode tube. In any case described above, the light emitted from the light emitting device is mixed while passing through the light guiding plate. By this, irregularity in color can be more reduced.

### <Light Guiding Plate>

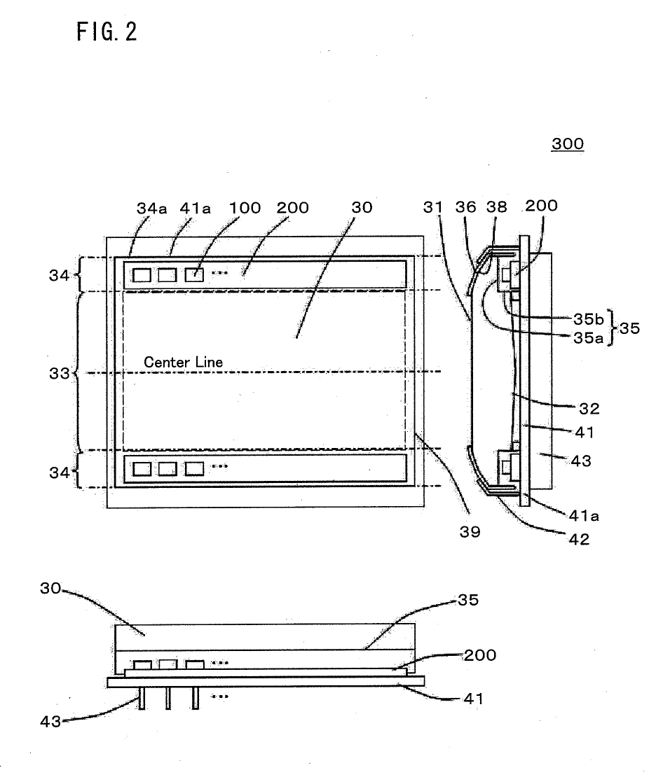

FIG. 2 is a view showing an arrangement of a surface light source. A surface light source 300 includes a light guiding plate 30 for receiving light from an array light source 200 so as to diffuse and emit the light. The light guiding plate 30 is suitably formed from a highly transparent material such as a polycarbonate and an acrylic.

In the light guiding plate 30, scattering particles (not shown), such as silica and polymers, for scattering light in the light guiding plate 30 are dispersed for the purpose of extracting light to be emitted and producing a uniform emission intensity in a surface of the surface light source.

The surface light source 300 is described below by separating into two regions: a main region 33 including a vicinity of a center line running in a longitudinal direction of the light guiding plate 30; and an end region 34 extending along an upper and lower ends of the main region 33.

The main region 33 of the light guiding plate 30 includes a light emitting surface 31 from which light is emitted, a back surface 32 facing the light emitting surface 31, and side end faces 39 that are a pair of end faces formed on the right and left of the light guiding plate 30, respectively, so as to face each other and to intersect with an end section 34a of the light guiding plate 30 at right angles.

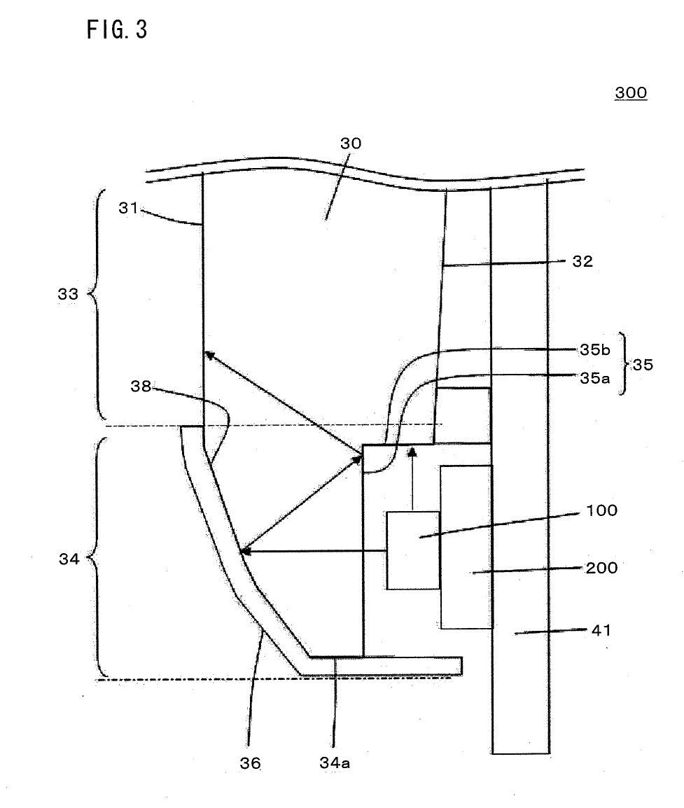

FIG. 3 is a view showing a cross-sectional structure of an end region of a light guiding plate. A light guiding plate 30 has a flat light emitting surface 31 in a main region 33. Meanwhile, in an end region 34, the light guiding plate 30 has an inclining surface 38 that extends along end sections 34a so that the light guiding plate 30 becomes thinner toward the upper and lower end sections 34a of the light guiding plate 30. The inclining surface 38 reflects light entering from a first light incident end face 35a to be described.

The inclining surface 38 is provided with a reflecting member 36 for covering the inclining surface 38. The reflecting member 36 causes a mirror reflection so as to increase use efficiency of the light. It is preferable that all components of the light are totally reflected by the inclining surface 38. However, thinning the light guiding plate 30 causes an increase in amount of the light component that do not satisfy a condition of total reflection. This may cause a reduction in use efficiency of the light. With the reflecting member 36, it becomes possible to make the light guiding plate 30 thinner and to suppress the reduction in use efficiency of the light. It is preferable that the reflecting member 36 covers up to at least a region that does not satisfy the condition of total reflection.

The inclining surface 38 is not limited to a flat inclining surface and may be a curved surface. Further, the inclining surface 38 may have such a shape that causes total reflection. In this case, it is not necessary to provide the reflecting member 36.

The back surface 32 inclines so that the light guiding plate 30 becomes thickest near the center line of the light guiding plate 30 and becomes thinner toward the upper and lower end sections 34a of the light guiding plate 30. Therefore, the light guiding plate 30, excluding a later-mentioned light incident end face 35 and the like, roughly has a wedge-shaped vertical cross-section.

The back surface 32 in the end region 34 includes a notch that is linearly formed along the end section 34a. The notch depresses toward the light emitting surface 31 from a virtual extension surface of the back surface 32. A surface of the notch serves as a light incident end face 35. The notch has an L-shaped cross section in which the fold of L shape is positioned close to the center line of the light guiding plate 30. The light incident end face 35 is constituted by a first light incident end face 35a which is parallel to the light emitting surface 31 in the main region 33, and a second light incident end face 35b which is perpendicular to the light incident end face 35a. The light emitting device 100 is provided so as to be adjacent to the notch.

In this arrangement, light entering from the first light incident end face 35a is reflected by the inclining surface 38 itself or the reflecting member 36 and then totally reflected by the first light incident surface 35a so as to enter the main region 33 of the light guiding plate 30.

That is to say, the first light incident end face 35a serves as a reflecting surface by which light in the light guiding plate is totally reflected, and also as a surface from which light from a light source enters.

The light guiding plate 30 can be produced by a method in which a plate having a flat pentagon-shaped cross-section is formed in advance by extrusion molding before the light incident end face 35 is formed. The light incident end face 35 can be formed, for example, by cutting the plate by laser processing.

The light guiding plate 30 also can be produced by compression molding which uses a female die that has a shallow dish-shaped recess section, which corresponds to the shape of the light guiding plate 30.

One main feature of the present invention is to have the above-mentioned arrangement of the light incident end face 35. Therefore, the light guiding plate 30 is not limited to the shape mentioned above. For example, the light guiding plate 30 may have an inclining back surface 32 so as to become thinnest near the center line of the light guiding plate 30 and become thicker toward the upper and lower end sections of the light guiding plate 30. Alternatively, the light guiding plate 30 may have an inclining surface so as to monotonically decrease in thickness toward either one of the upper and lower end sections of the light guiding plate 30; and a later-mentioned array light source 200 is provided at either one of the end sections. Alternatively, the light emitting surface 31 may be parallel to the back surface 32, that is to say, the light guiding plate 30 may have a uniform thickness.

Further, for the purpose of extracting light to be emitted and producing uniform emission intensity in a surface of the surface light source, the back surface 32 of the light guiding plate 30 may include a dot pattern or a graining pattern instead of the scattering particles. Further, for the purpose of extracting the light to be emitted and for other purpose, a reflecting sheet may be provided adjacent to the back surface 32.

### <Surface Light Source>

A surface light source 300 shown in FIG. 2 includes a frame 41, an array light source 200 provided on the frame 41, a light guiding plate 30 for receiving light from the array light source 200 so as to diffuse and emit the light, and the like.

The array light source 200 is provided on a surface of the frame 41 along upper and lower end sections 41a of the light guiding plate 30, respectively. The light guiding plate 30 is provided so that the array light source 200 is contained in a notch of the light guiding plate 30. At this point, a light emitting surface of the light emitting device 100 faces a first light incident end face 35a of the light guiding plate 30 so that light from the light emitting device 100 enters the first light incident end face 35a at substantially right angles. Further, a gap is formed between the light incident end face 35 and the light emitting device 100 so as to absorb a size change of the light guiding plate 30 caused by a change in surrounding temperature.

In each of upper and lower end regions 34 of the light guiding plate 30, a reflecting member 36 is provided so as to cover an inclining surface 38 and a side part of the light emitting device 100.

The frame 41 is preferably formed from a metal or the like, which achieves a high mechanical strength and a high heat release, so as to support the array light source 200, the light guiding plate 30, and the like and to suppress an increase in temperature of the surface light source 300.

Further, it is preferable that ribs 43 to provide surface unevenness are provided on a back surface of the frame 41. This makes it possible to increase a surface area for releasing heat and to increase mechanical strength, so that the frame 41 can be reduced in thickness. In addition, by providing the rib 43 in a vertical direction, that is, in a direction perpendicular to the center line of the light guiding plate 30, the heat can be more efficiently released by convection flow from a lower part to an upper part of the frame 41.

The light guiding plate 30 is loosely attached to the frame 41 with clips 42 provided along the upper and lower end sections 41a of the frame 41. This allows the surface light source 300 to absorb a shock or a size change of the light guiding plate 30 caused by a change in surrounding temperature.

The following description deals with an action of the surface light source 300. Light emitted from the light emitting device 100 enters the light incident end face 35 directly or after being reflected by the reflecting member 36 that is provided adjacent to the light emitting device 100. As shown in FIG. 3, an optical component of the light entering from the first light incident end face 35a is reflected by the inclining surface 38 and then totally reflected by the first light incident surface 35a so as to enter a main region 33 of the light guiding plate 30. Meanwhile, an optical component of the light entering from a second light incident end face 35b directly enters the main region 33 of the light guiding plate 30.

In this way, the light emitted from the light emitting device 100 enters the light guiding plate 30. Then, the light passes through the light guiding plate 30 while being scattered by scattering particles (not shown) provided inside the light guiding plate 30, so as to be emitted from a light emitting surface 31 of the light guiding plate 30 directly or after being reflected by a back surface 32.

In the surface light source of the present embodiment, angular dependence of emission intensity of the light emitting device 100 is represented by the Lambertian distribution; and an optical axis of light from the light emitting device 100 is substantially parallel to a perpendicular line of the first light incident end face 35a. This causes a ratio of light entering the light guiding plate 30 via the first light incident end face 35a to be higher than that of light entering the light guiding plate 30 via the second light incident end face 35b.

Next, effects of the surface light source 300 are described below. With the surface light source 300, it is possible to suppress a change in coupling efficiency of light between the first light incident end face 35a and the array light source 200, which change is caused by a change in surrounding temperature. As described above, the size of the light guiding plate 30 changes in response to the surrounding temperature. However, in the surface light source 300, the gap between the first light incident end face 35a and the light emitting surface of the light emitting device 100 changes its size in response to only a size change in thickness direction of the light guiding plate 30. The size change in thickness direction of the light guiding plate 30 is extremely smaller than that in longitudinal direction of the light guiding plate 30. Therefore, it is possible to reduce the change in the coupling efficiency. This effect is effective particularly in a case where the light guiding plate 30 has a large size.

Further, with the surface light source of the present embodiment, it is possible to achieve a high degree of freedom of heat release designing in the surface light source 300. With the arrangement of the surface light source of the present embodiment, the frame 41 can have a heat release function by being provided with the rib 43, for example. This enables the surface light source to easily have a large area for releasing heat. Moreover, in the surface light source 300, the array light source 200 includes a mounting substrate 21 that is directly provided on the frame 41. This causes heat generated by the array light source 200 to be released outside exclusively via the frame 41. As described above, the heat generated by the array light source 200 transfers at a short distance until being released, through a path having a large cross-section area. Therefore, it is possible to increase a degree of freedom of designing for achieving a high heat release. In addition, the surface light source 300 can be advantageously reduced in weight with simple means for releasing the heat.

Furthermore, the surface light source of the present embodiment can be advantageously reduced in thickness because the array light source 200 is contained in the notch in the end region 34 of the light guiding plate 30.

The light emitted from the light emitting device 100 in a direction parallel to the optical axis passes through a comparatively long path by being repeatedly reflected so as to enter the main region 33 of the light guiding plate 30. This facilitates mixing of the light emitted from the light emitting device 100. As a result, irregularity in color and in emission intensity can be suppressed.

When producing the surface light source of the present embodiment, the light guiding plate 30 can be easily attached only by placing in a predetermined position.

Further, it is possible to mount a resin mold type light emitting device, which achieves a high light extraction efficiency as described above. This makes it possible to advantageously reduce power consumption.

### Second Embodiment

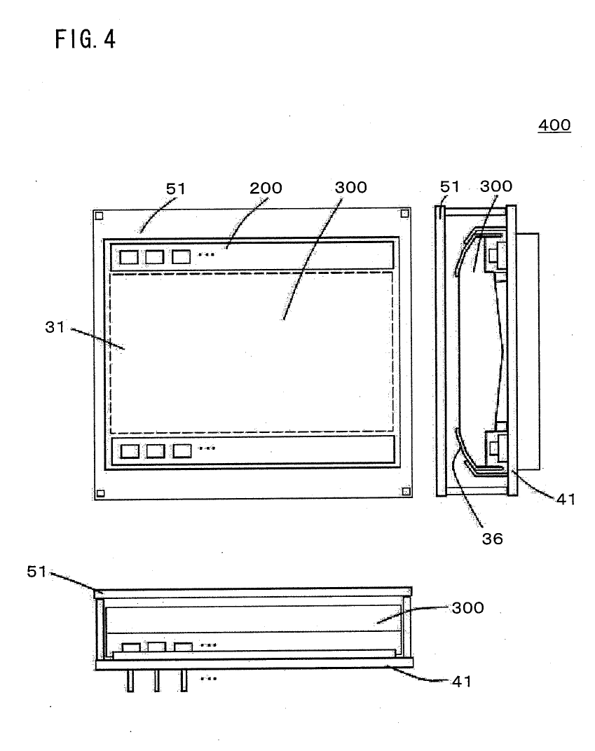

Another embodiment of the present invention is described below with reference to FIG. 4.

FIG. 4 is a cross-sectional view of a liquid crystal display device.

A liquid crystal display device 400 includes a surface light source 300 and a liquid crystal display panel 51 that is provided on the surface light source 300 via an optical sheet (not shown), such as a light-harvesting sheet and a diffusing sheet, provided directly on the surface light source 300. The surface light source 300 backlights the liquid crystal display panel 51.

The liquid crystal display panel 51 includes an effective display region in which pixels are provided, and a peripheral section that surrounds the effective display region and does not directly contribute to image display. At least the effective display region is irradiated with light emitted from a light emitting surface 31. Further, an end region 34 including a reflecting member 36 and the like is preferably provided in the peripheral section, that is, on a backside of a picture frame.

This allows the liquid crystal display device 400 to decrease in thickness and weight by using the surface light source 300. In addition, the liquid crystal display device 400 becomes attractive in appearance by having a narrow frame.

### Third Embodiment

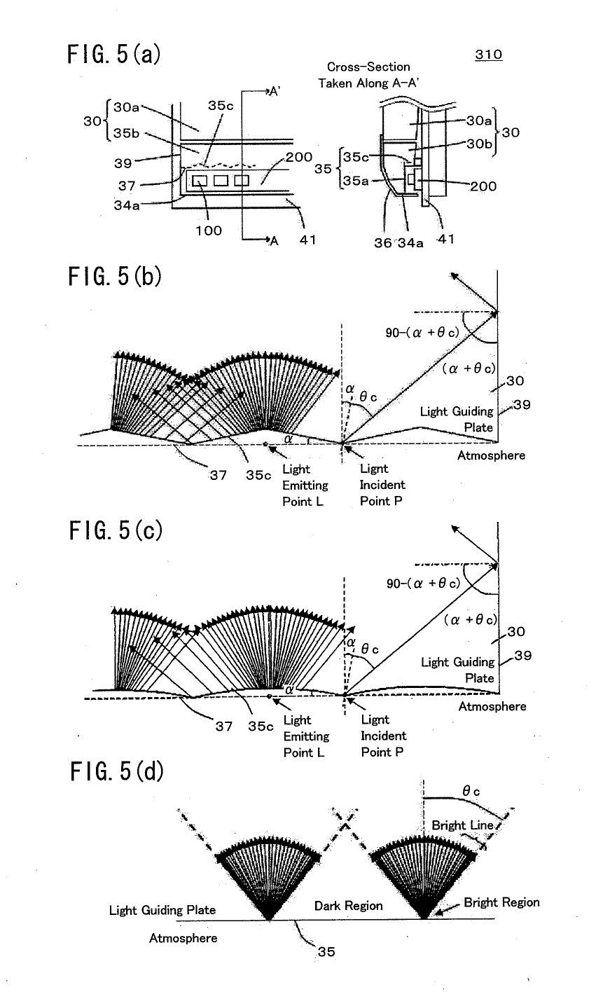

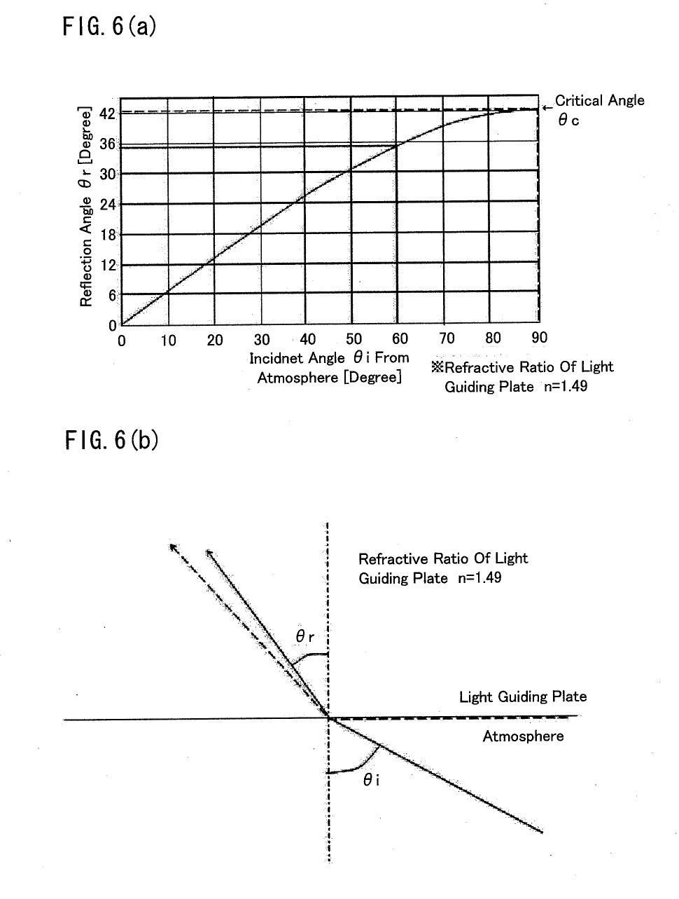

A still another embodiment of the present invention is described below with reference to FIG. 5(a) through FIG. 6(c).

FIG. 5(a) is a view showing a vicinity of an end region of a surface light source in accordance with the present embodiment. A surface light source 310 of the present embodiment is uniquely configured in that a light guiding plate 30 is separated by a gap into a light guiding plate 30a including the center line of the light guiding plate 30 and a light guiding plate 30b including a second light incident end face 35c. Further, a light incident tangential plane 37, which is a tangential plane of the second light incident end face 35c, is provided along an end section 34a of the light guiding plate 30b and includes the second light incident end face 35c having a plurality of recess sections that are continuously formed. That is to say, the second light incident end face 35c has the plurality of recess sections so as to have a triangular cross-section. A pitch between triangles formed by the recess sections is equal to that between light emitting devices 100 mounted on an array light source 200 that is provided so as to face the second light incident end face 35c. It is preferable that a reflecting member 36 is provided so as to cover the gap.

In this arrangement, light emitted from the light emitting device 100 changes its traveling direction because of the light guiding plate 30b so as to enter, via the gap, an end face of the light guiding plate 30a directly or after being reflected by the reflecting member 36. The second light incident end face 35c, which has the triangular cross-section, makes it possible to suppress occurrence of a bright line or a bright and dark regions.

As described later, light passing through the light guiding plate 30 is totally reflected by a side end face 39 when an inclined angle α between the second light incident end face 35c and the light incident tangential plane 37 is appropriately set. This makes it possible to improve use efficiency of the light.

Angular dependence of emission intensity of the light emitting device 100 is represented by the Lambertian distribution. Therefore, a ratio of light entering the light guiding plate 30 via the second light incident end face 35c is lower than that of light entering the light guiding plate 30 via the first light incident end face 35a. However, with the arrangement above, it is possible to further suppress the occurrence of the bright line and the like.

The following description deals with an action of the second light incident end face 35c. FIG. 6(a) and FIG. 6(b) are views each showing a relation between an incident angle and a reflection angle at a boundary surface between atmosphere and a light guiding plate. On a light incident end face 35, the incident angle and an output angle to a light guiding plate 30 are indicated by θi and θr, respectively. According to Snell's law, when θi is increased from 0 degree to 90 degrees, θr increases in response to the increase in θi; and when θi is 90 degrees, θr becomes a critical angle θc, which is the upper limit of θr. When a refractive index of the light guiding plate 30 is indicated by n, the critical angle θc is indicated by the following equation: θc=arc sin(1/n).

For example, as shown in FIG. 6(a), when the refractive index n of the light guiding plate 30 is 1.49, θc is 42.1 degrees. When θi increases from 0 degree to 60 degrees, θr increases from 0 degree to 35.5 degrees. This means that θr increases by 0.59 degrees per 1-degree increase of θi. Likewise, when θi increases from 60 degrees to 90 degrees, θr increases from 35.5 degrees to 42.1 degrees. This means that θr increases by 0.22 degrees per 1-degree increase of θi.

As described above, θr linearly increases at first and then increases by such an amount that is gradually decreased in response to the increase of θi. This means that optical density becomes greater in response to θr becoming closer to θc. Therefore, light passing with an output angle of approximately θr generates a bright line.

The following description deals with a preferable inclined angle α of the second light incident end face 35c. FIG. 5(b) through FIG. 5(d) are views each explaining a light trace in a vicinity of an end region of a surface light source.

When light enters a flat light incident end face, a bright line or a bright and dark regions occur as shown in FIG. 5(d) for the reason described above. On the other hand, as shown in FIG. 5(b), when light enters a light incident end face 35c having a triangular cross-section, an incident angle decreases by an inclined angle α, so that occurrence of the bright line can be suppressed.

A greater inclined angle α causes light passing through the light guiding plate 30 to enter the side end face 39 at an angle that is closer to a right angle. At a certain point of the inclined angle α, the light comes not to satisfy a condition of total reflection at the side end face 39, thereby leaking into atmosphere. Therefore, by setting the inclined angle α so that the light is totally reflected by the side end face 39, it is possible to improve use efficiency of the light. Specifically, it is preferable that the inclined angle α is (90−2·θc) or less, that is, (90−2·arc sin(1/n)) or less. This is based on the following reason.

In FIG. 5(b), an inclined angle between a second light incident end face 35c and a light incident tangential plane 37 is indicated by α. In order to find the condition of total reflection at the side end face 39, what is required is examination with regard to only a trace of light that enters the side end face 39 at an angle that is closest to a right angle. Discussed below is a trace of light that enters a light incident point P, which indicates an intersection of the second light incident end face 35c and the light incident tangential plane 37.

Light entering the light incident point P at the largest incident angle passes through the light guiding plate 30 by forming an angle of (α+θc) with a perpendicular line of the light incident tangential plane 37, and then enters the side end face 39 at an incident angle of (90−(α+θc)).

When the incident angle of (90−(α+θc)) is larger than a critical angle θc, the light passing through the light guiding plate 30 is totally reflected by the side end face 39. Therefore, the condition of the total reflection is indicated by the following inequation:

90−(α+θc)>θc [degree], simplified into (90−2·θc)>α[degree]

The light entering the light incident point P at the largest incident angle means light entering the light incident point P by passing along a surface of the second light incident end face 35c. However, in an actual surface light source, a light emitting point L is located separately from the second light incident end face 35c. Therefore, a may have a slightly greater value than above.

In this way, light entering from the second light incident end face 35c is diffused by the triangle so as to reach the side end face 39. Then, the light is totally reflected, thereby passing through the light guiding plate again. This achieves a high use efficiency of the light. Further, since the light incident points P are located all over the second light incident end face 35c, it is possible to reduce a difference in emission intensity between a bright region and a dark region.

In FIG. 5(a), pitches between the light emitting devices 100 are equal to and respectively face straight to pitches between the triangles formed by the second light incident end surface 35c. However, the present invention is not limited to this. For example, the light emitting device 100 may be located so as not to be on a center line of the triangle. In this case, it is possible to suppress occurrence of the bright line or the bright and dark regions although light traces are not symmetrically positioned.

A surface light source of the present embodiment may include both of or either one of the following arrangements: (i) the light guiding plate 30 is separated into the light guiding plate 30a and the light guiding plate 30b; (ii) the second light incident end face 35c has a triangular cross-section.

Further, by arranging so that the second light incident end face 35c has a shape of depressed circular arc or has a rough surface as shown in FIG. 5(c), it is possible to suppress occurrence of the bright line or the bright and dark regions. In a case where the second light incident end face 35c has the shape of depressed circular arc, it is preferable, for the same reason as above, that an tangential plane of the depressed circular arc forms an angle of (90−2·θc) or less with the light incident tangential plane 37 at an intersection of the depressed circular arc and the light incident tangential plane 37.

By arranging so that the light guiding plate 30b does not include scattering particles, it is possible to attain a high use efficiency of the light. The inclined angle α is set so that light entering from the second light incident end face 35c satisfies the condition of total reflection at the side end face 39. On the other hand, the scattering particles may cause part of the light not to satisfy the condition of total reflection and to thus leak into atmosphere, while the scattering particles function to scatter light in the light guiding plate so as to extract light to be emitted. Therefore, it may be preferable that the light guiding plate 30b is arranged so as not to include the scattering particles.

The light guiding plate 30 can be easily produced because the light guiding plate 30 is separated into the light guiding plate 30b, which has a complicated shape formed with the light incident end face 35, and the light guiding plate 30a, which has a simpler shape than the light guiding plate 30b. It is possible to advantageously improve processing accuracy and production yield by producing the light guiding plate 30b, which has a small and complicated cross-section, separately from the light guiding plate 30a, for example.

### Summary of Embodiments

The present invention is not limited to the description of the embodiments above, but may be altered by a skilled person within the scope of the claims. An embodiment based on a proper combination of technical means disclosed in different embodiments is encompassed in the technical scope of the present invention.

A surface light source in accordance with the present embodiment is a surface light source including: a light guiding plate including, in a main region, a light emitting surface for emitting light and a back surface facing the light emitting surface; a light source being provided on a back surface side in an end region of the light guiding plate, and emitting the light to be emitted from the light emitting surface; an inclining surface being formed along an end section on the light emitting surface side in the end region so that the light guiding plate becomes thinner toward the end section; a reflecting member covering the inclining surface; and a light incident end face being provided on the back surface side and extending along the end section, the inclining surface being formed so that light entering the light incident end face at a right angle is totally reflected by the light incident end face after being reflected by the inclining surface or the reflecting member.

It is preferable that the surface light source of the present embodiment is arranged so that: the end region of the light guiding plate has a notch between a first light incident end face and a second light incident end face; the notch is provided along an end section of the back surface and is depressed toward the light emitting surface from a virtual extension surface of the back surface, the first light incident end face is formed between the light source and the inclining surface; and the second light incident end face is substantially perpendicular to the first light incident end face.

It is preferable that the surface light source of the present embodiment is arranged so that: the second light incident end face has a plurality of recess sections; and a surface formed with the plurality of recess sections forms an angle of (90−2·arc sin(1/n)) or less with a tangential plane of the second light incident end face, where n is a refractive index of the light guiding plate 30.

It is preferable that the surface light source of the present embodiment is arranged so that the recess sections have a shape of substantially circular arc.

It is preferable that the surface light source of the present embodiment is arranged so that the recess sections have a triangular shape.

A liquid crystal display device of the present embodiment is a liquid crystal display device including: a liquid crystal display panel; and a surface light source including: a light guiding plate including, in a main region, a light emitting surface for emitting light and a back surface facing the light emitting surface; a light source being provided on a back surface side in an end region of the light guiding plate, and emitting the light to be emitted from the light emitting surface; an inclining surface being formed along an end section on the light emitting surface side in the end region so that the light guiding plate becomes thinner toward the end section; a reflecting member covering the inclining surface; and a light incident end face being provided on the back surface side and extending along the end section, the inclining surface being formed so that light entering the light incident end face at a right angle is totally reflected by the light incident end face after being reflected by the inclining surface or the reflecting member, the liquid crystal display panel being backlighted by the surface light source.

With the arrangements, a surface light source arranged as in the embodiments of the present invention and a liquid crystal display device including the surface light source can have a high degree of freedom of heat release designing and advantageously achieve increase in size and decrease in thickness of the surface light source, and decrease in thickness of frame of the display device.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A surface light source comprising:
a light guiding plate including, in a main region, a light emitting surface for emitting light and a back surface facing the light emitting surface;
a light source being provided on a back surface side in an end region of the light guiding plate, and emitting the light to be emitted from the light emitting surface;
an inclining surface being formed along an end section on the light emitting surface side in the end region so that the light guiding plate becomes thinner toward the end section;
a reflecting member covering the inclining surface; and
a light incident end face being provided on the back surface side and extending along the end section,
the inclining surface being formed so that light entering the light incident end face at a right angle is totally reflected by the light incident end face after being reflected by the inclining surface or the reflecting member.

2. The surface light source according to claim 1, wherein:
the end region of the light guiding plate has a notch between a first light incident end face and a second light incident end face,
the notch is provided along an end section of the back surface and is depressed toward the light emitting surface from a virtual extension surface of the back surface,
the first light incident end face is formed between the light source and the inclining surface, and the second light incident end face is substantially perpendicular to the first light incident end face.

3. The surface light source according to claim 2, wherein:
the second light incident end face has a plurality of recess sections; and
a surface formed with the plurality of recess sections forms an angle of (90−2·arc sin(1/n)) or less with a tangential plane of the second light incident end face, where n is a refractive index of the light guiding plate.

4. The surface light source according to claim 3, wherein the recess sections have a shape of substantially circular arc.

5. The surface light source according to claim 3, wherein the recess sections have a triangular shape.

6. A liquid crystal display device comprising:
a liquid crystal display panel; and
a surface light source including:
a light guiding plate including, in a main region, a light emitting surface for emitting light and a back surface facing the light emitting surface;
a light source being provided on a back surface side in an end region of the light guiding plate, and emitting the light to be emitted from the light emitting surface;
an inclining surface being formed along an end section on the light emitting surface side in the end region so that the light guiding plate becomes thinner toward the end section;
a reflecting member covering the inclining surface; and
a light incident end face being provided on the back surface side and extending along the end section,
the inclining surface being formed so that light entering the light incident end face at a right angle is totally reflected by the light incident end face after being reflected by the inclining surface or the reflecting member,
the liquid crystal display panel being backlighted by the surface light source.
